(19) United States
(12) Patent Application Publication
(10) Pub. No.: US 2008/0283699 A1
(43) Pub. Date: Nov. 20, 2008

(54) STAND FOR A DRYING GUN SUPPORTING FRAME

(76) Inventor: Wuu-Cheau Jou, Taichung Hsien (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/748,694

(22) Filed: May 15, 2007

(51) Int. Cl. F16M 11/00

(52) U.S. Cl. 248/176.1

(57) ABSTRACT

A stand for a drying gun supporting frame includes a body and a socket at 90 degrees to the body. A spherical valve is disposed in the body, and a connecting unit is provided at the top of the body. The socket has a threaded hole at one side to receive a manual screw therein so as to secure a balancing pipe thereat. The spherical valve disposed in the body comprises a ball, washers, a cap and a linking rod. The altitude of the spherical valve is lower than the center of the balancing pipe, which lowers the outlet of the drying gun and provides a steady operation of the drying gun.

### BACKGROUND OF THE INVENTION

1. Field of the Invention

The present invention relates to a stand for a drying gun supporting frame, and more particularly to a stand for supporting a drying gun at a lower position to provide a steady operation status.

2. Description of the Prior Art

As shown in FIG. 6, a conventional drying gun supporting frame 1 comprises a stand 12 on a balancing pipe 11. The stand 12 is slidable and rotatable with respect to the balancing pipe 11. An air pipe 13 is provided at one side of the stand 12 for supplying pressurized air. The top of the stand 12 is connected with a female quick connector 14 to secure a drying gun 15 thereon. The bottom of the drying gun 15 is provided with a spherical valve 16, as shown in FIG. 7. The bottom of the spherical valve 16 is connected with a male quick connector 17 which is to facilitate quick connection with the female quick connector 14.

As shown in FIGS. 7 and 8, there are three members mounted between the balancing pipe 11 and the drying gun 15, which makes the height H too high. When turning the drying gun 15, it requires excessive torque, causing the drying gun 15 in an unstable condition so that it is hard to secure with a nut 18. The spherical valve 16, the male quick connector 17, and the female quick connector 14 are connected between the stand 12 and the drying gun 15, the higher cost and more labor requirement it will be, and the less it will be to compare with other products.

### SUMMARY OF THE INVENTION

A stand for a drying gun supporting frame comprises a body and a socket at 90 degrees to the body. The body comprises a spherical valve controlling the quantity of pressurized air flow. The spherical valve comprises a ball, washers, a cap and a linking ring. The top of the body is connected with a connecting unit. The connecting unit comprises a locking member and a rotatable member. The drying gun is secured to the connecting unit.

It is the main object of the present invention to provide a stand for a drying gun supporting frame, which is designed to have a lower altitude between the balancing pipe and the drying gun outlet so as to provide a stability of the drying gun.

### BRIEF DESCRIPTION OF THE DRAWINGS

FIG. 1 is an exploded view of a preferred embodiment of the present invention;

FIG. 2 is a side cross-sectional view of the preferred embodiment of the present invention;

FIG. 3 is a side cross-sectional view showing assembly of a rotatable member of a connecting unit and a linking ring of the preferred embodiment of the present invention;

FIG. 4 is a side cross-sectional view of the preferred embodiment of the present invention connected with a drying gun and an air pipe;

FIG. 5 is a side view of the preferred embodiment of the present invention showing replacement of a female quick connector;

FIG. 6 is a side view of a drying gun with a supporting frame of the prior art;

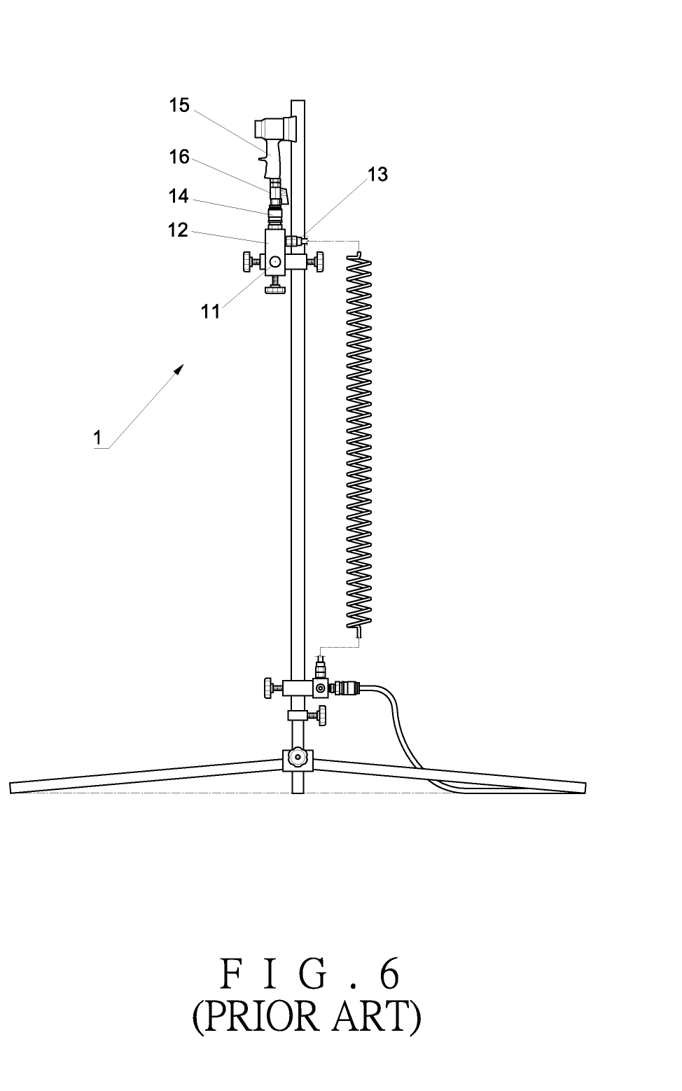

FIG. 7 is an enlarged view of the prior art; and

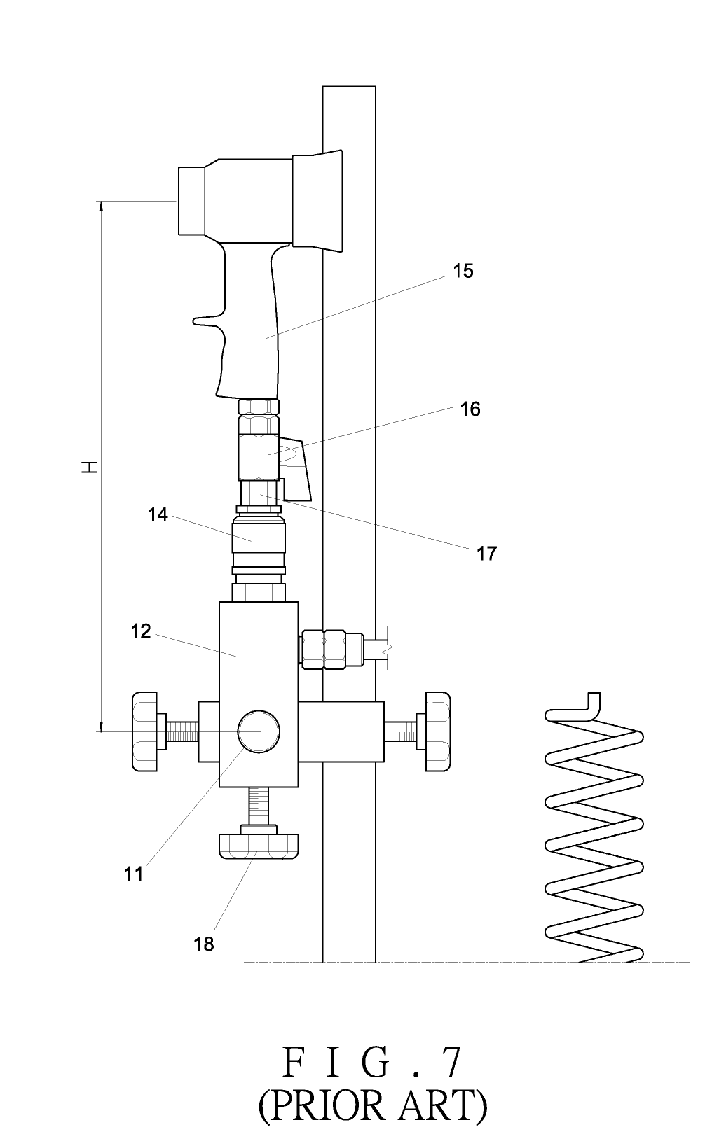

FIG. 8 is a side view of the prior art showing rotation of the drying gun.

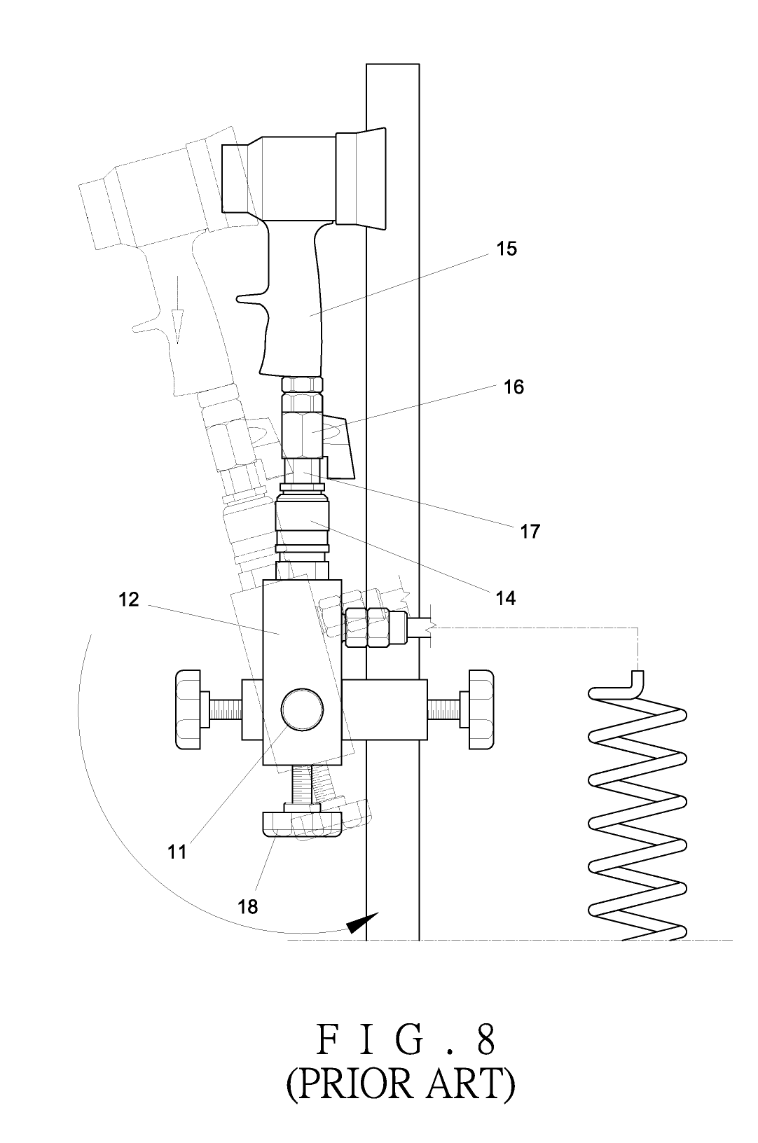

### DETAILED DESCRIPTION OF THE PREFERRED EMBODIMENT

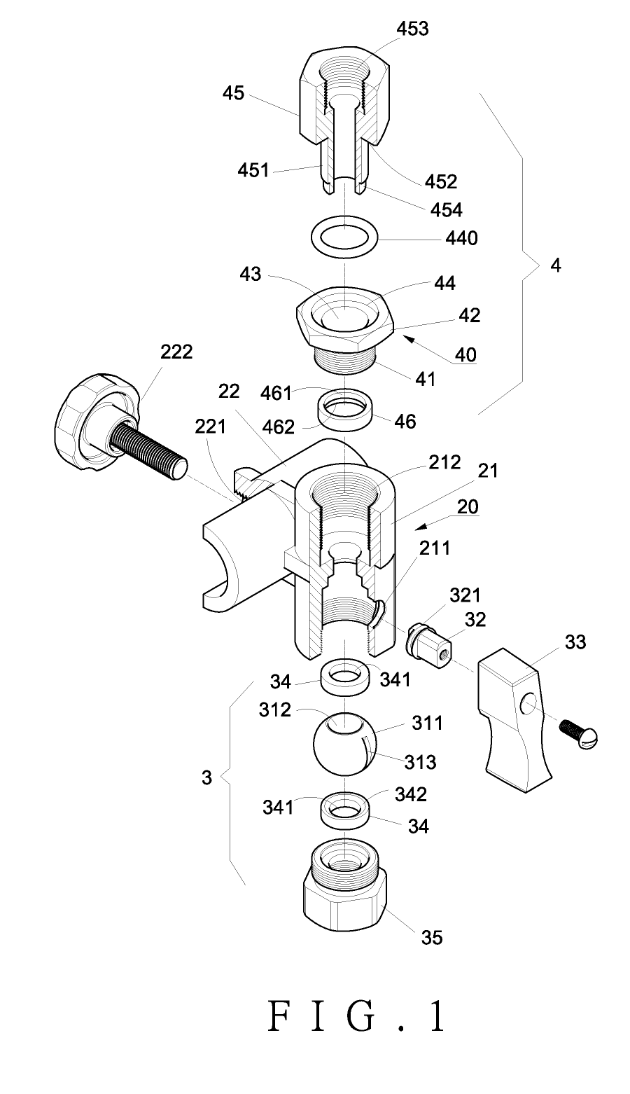

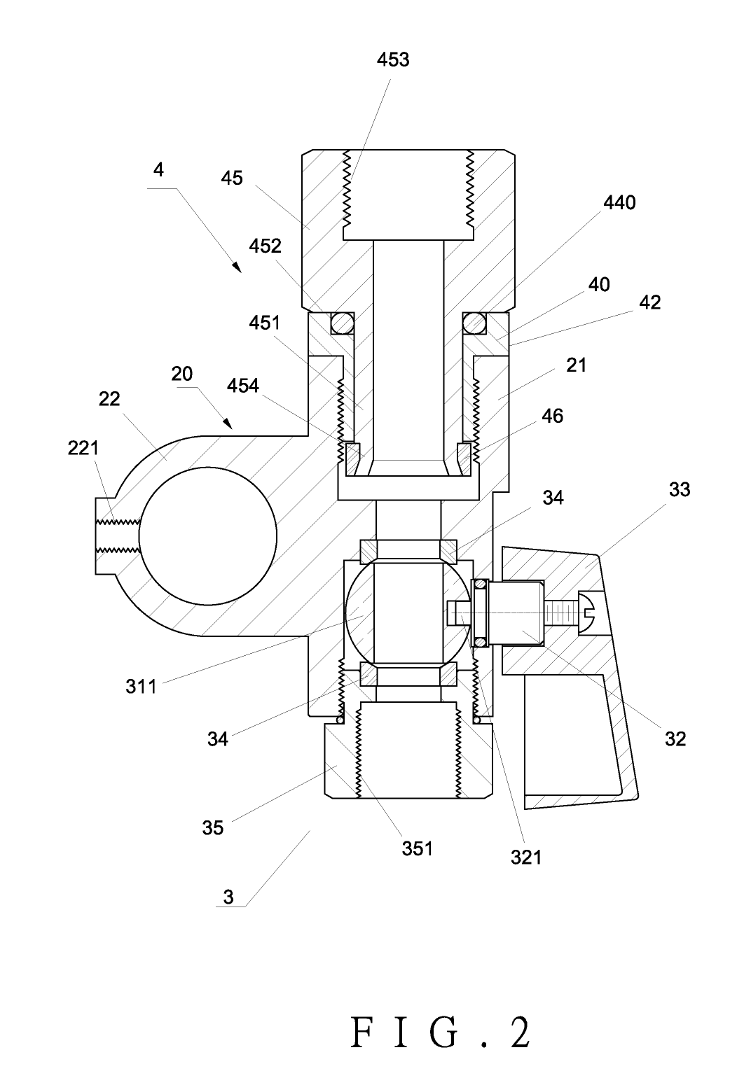

As shown in FIGS. 1 and 2, the present invention comprises a stand 20 having a body 21 and a socket 22 at 90 degrees to the body 21.

The body 21 is a hollow tube adapted to receive a spherical valve 3 therein. A connecting unit 4 is pivotally connected to the top of the body 21.

The socket 22 is a hollow tube having a threaded hole 221 at one side for a manual screw 222 to be threaded therein.

The spherical valve 3 accommodated in the body 21 comprises a ball 311 having a through hole 312 therein. The ball 311 has two flat ends. One side of the ball 311 is formed with a slot 313 for engagement of a tenon 32 provided at one end of a linking rod 32. The other end of the linking rod 32 protrudes outwardly from an aperture 211 of the body 21 and is secured with a knob 33. Two washers 34 are disposed at the two flat ends of the ball 311. Each washer 34 has a central hole 341 and a cone edge 342 which is in touch with the ball 311. A cap 35 is threaded to the bottom of the body 21 to facilitate the engagement of the washer 34 and the ball 311.

The connecting unit 4 secured on the top of the body 21 comprises a locking member 40, a rotatable member 45 and a linking ring 46. The locking member 40 comprises a threaded section 41 at one end which matches with inner threads 212 of the body 21 so that the locking member 40 is threaded to the body 21. The other end of the locking member 40 is formed with a ledge section 42 which engages with the outer edge of the body 21 when the locking member 40 is secured to the body 21. A through hole 43 is formed in the locking member 40, and a chamber 44 is formed at one end of the through hole 43. A washer 440 is disposed in the chamber 44.

The rotatable member 45 is hollow and comprises a reduced section 451. The reduced section 451 is inserted into the through hole 43 of the locking member 40 and remains a gap that allows the reduced section 451 rotating within the through hole 43. The reduced section 451 has a shoulder 452 to engage with the washer 440 of the locking member 40 to prevent air leakage. One end of the rotatable member 45 has an inner threaded hole 453 for connection with a drying gun. An insertion section 454 is formed at the bottom of the rotatable member 45.

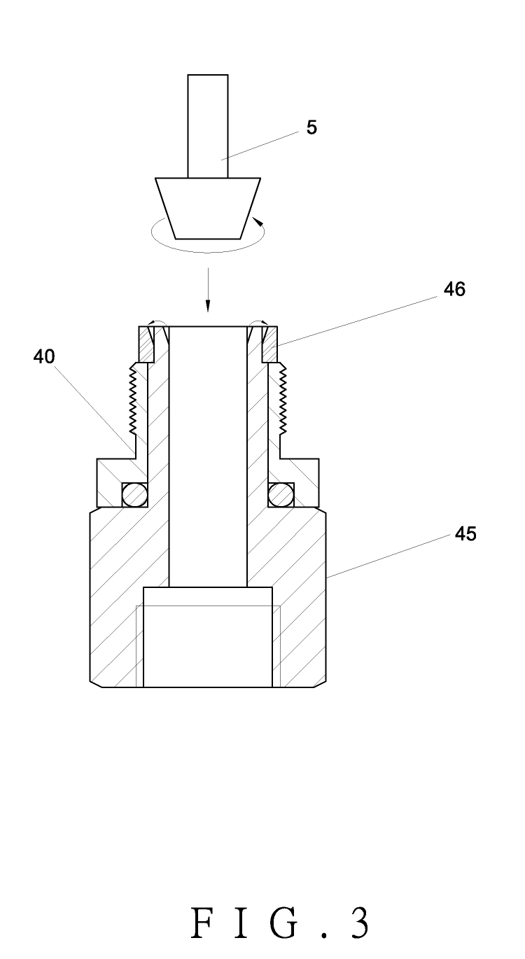

The linking ring 46 is inserted onto the insertion section 454, and has an inner hole 461 and a conical hole 462. The rotatable member 45 and the linking ring 46 are integrated by pressing and twisting forces from a pressing tool 5, as shown in FIG. 3. This prevents the rotatable member 45 and the linking ring 46 from disengagement.

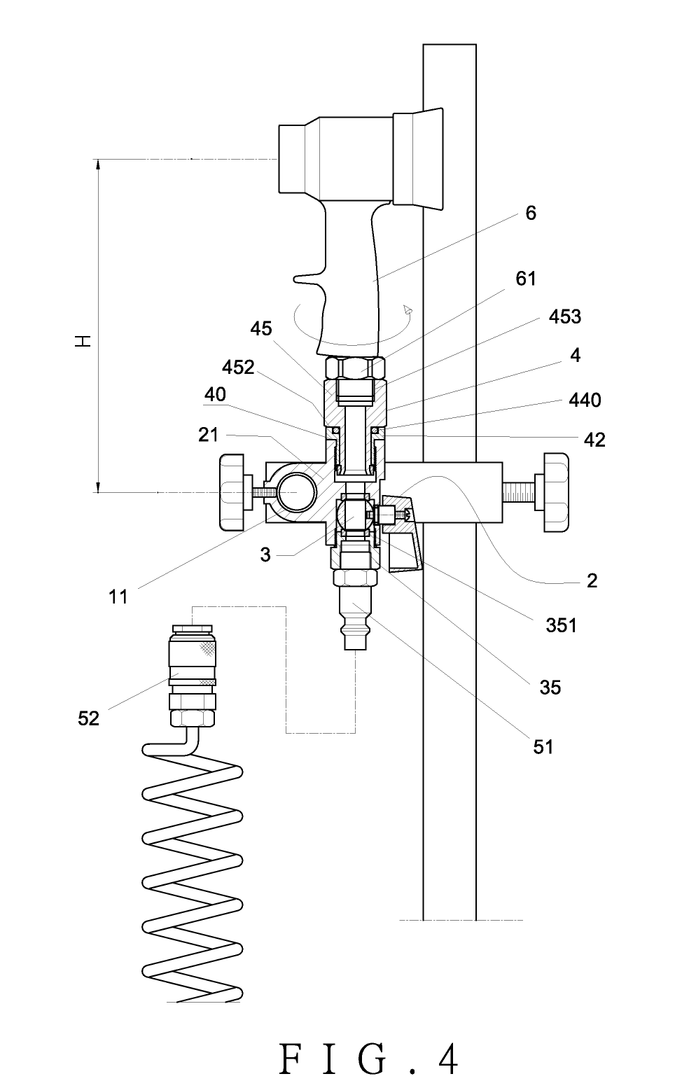

As shown in FIGS. 2 and 4, the spherical valve 3 is located in the stand 2. The cap 35 has an inner threaded hole 351 for connection of a male quick connector 51. The male quick connector 51 is adapted to connect with an air pipe 52 for pressurized air supply. The spherical valve 311 controls air flow into a drying gun 6.

Referring to FIGS. 2 and 4, the connecting unit 4 secured on the top of the body 21 is adapted to connect with the drying gun 6 thereon to facilitate rotation of the drying gun 6. The washer 440 is located between the shoulder 452 of the rotatable member 45 and the ledge section 42 of the locking member 40 to prevent air leakage and to provide a friction to restrain excessive rotation of the drying gun 6.

The other improvement of the present invention is to lower the height H between the air outlet of the drying gun 6 and the center of the balancing pipe 11, as shown in FIG. 4, which means the spherical valve 3 located in the body 21 is at an altitude lower than the center of the balancing pipe 11. The connecting unit 4 is connected to the top of the body 21, thus the spherical valve 16, the male quick connector 17 and the female quick connector 14 of the prior art parts are all eliminated. This also lowers down the height H of the air outlet of the drying gun 6 with respect to the center of the balancing pipe 11. In this example, the height H of the present invention is 0.56 times than the prior art. The present invention provides a steady operation of the drying gun 6.

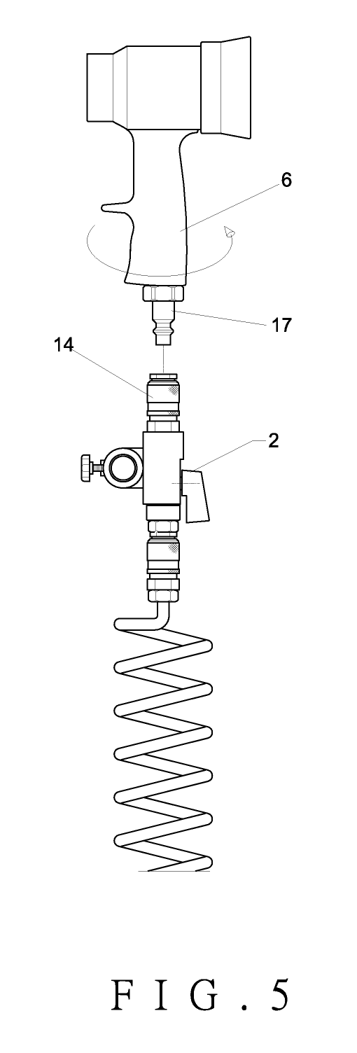

As shown in FIG. 4, a connecting head 61 of the drying gun 6 has threads and is connected with the inner threaded hole 453 of the rotatable member 45 of the connecting unit 4, As shown in FIG. 5, the bottom of the drying gun 6 is provided with the male quick connector 17, thus the connecting unit 4 provided on the top of the stand 2 can be replaced with the female quick connector 14 of the prior art, which is to be connected with the male quick connector 17 of the drying gun 6.

In accordance with the above description, the body of the present invention either mounted with the connecting unit or the female quick connector depending upon what the drying gun is mounted, either a connecting unit or a male quick connector. Furthermore, the spherical valve is mounted in the body directly, without any other parts, the altitude of the spherical valve is lower than the center altitude of the balancing pipe. In this example, the height is 0.56 times than the prior art, thus it is steady in operation.

What is claimed is:

1. A stand for a drying gun supporting frame comprising:
a hollow body accommodated with a spherical valve therein; and
a hollow socket vertical to said body having a threaded hole at one side to receive a manual screw therein;

2. The stand for a drying gun supporting frame, as recited in claim 1, wherein said spherical valve comprises a ball, said ball having a through hole and two flat ends, one side of said ball being formed with a slot for engagement of a tenon provided at one end of a linking rod, another end of said linking rod protruding from an aperture of said body, said linking rod being connected to a knob, two washers being provided at said flat ends of said spherical valve, each said washer having a central through hole and a cone edge at one side to be engaged with said spherical valve, a cap being provided at the bottom of said body to facilitate engagement of said washer and said spherical valve.

3. The stand for a drying gun supporting frame, as recited in claim 1, wherein the top of said body is pivotally connected with a connecting unit.

4. The stand for a drying gun supporting frame as recited in claim 3, wherein said connecting unit comprises:
a locking member having a threaded section at one end for connection with inner threads of said body, another end of said locking member being formed with a ledge section to be engaged with an outer edge of said body, a through hole and a chamber being disposed in said locking member, a washer being provided in said chamber;
a rotatable member being hollow and comprising a reduced section at one end thereof, said reduced section being inserted into said through hole of said locking member and remaining a gap that allows said rotatable member to rotate within said locking member, said reduced section having a shoulder to be engaged with said washer in said locking member, said rotatable member having an inner threaded hole at another end for connection of a drying gun, an insertion section being provided at the bottom of said rotatable member; and
a linking ring disposed on said insertion section, said linking ring having an inner hole and a conical hole, said rotatable member and said linking ring being integrated by pressing and twisting forces from a pressing tool.
